(19) United States
(12) Patent Application Publication
(10) Pub. No.: US 2026/0349428 A1
(43) Pub. Date: Nov. 5, 2026

(54) INFORMATION PROCESSING METHOD, INFORMATION PROCESSING APPARATUS, AND PROGRAM

(71) Applicant: SONY GROUP CORPORATION, TOKYO (JP)

(72) Inventor: ISHWAR PRAKASH HEBBAR, TOKYO (JP)

(21) Appl. No.: 19/486,979

(22) PCT Filed: May 27, 2024
(86) PCT No.: PCT/JP2024/019387

§ 371 Date: Nov. 24, 2025

(30) Foreign Application Priority Data
Jun. 13, 2023 (JP) 2023-096894

(51) Int. Cl. G05D 1/224; G05D 1/644; G05D 109/20; G05D 111/10

(52) U.S. Cl. CPC G05D 1/2247; G05D 1/644; G05D 2109/20; G05D 2111/10

(57) ABSTRACT

The present technology relates to an information processing method, an information processing apparatus, and a program capable of presenting a scanning path of an aerial imaging apparatus desired by a user. An imaging region-related information acquisition unit acquires imaging region-related information related to a desired imaging region of the drone. A condition acquisition unit acquires the priority of the scanning path condition of the drone. A display control unit causes the display unit to display the scanning path on the basis of the imaging region-related information acquired by the imaging region-related information acquisition unit and the priority acquired by the condition acquisition unit. The present technology can be applied to, for example, an information processing apparatus or the like that generates a scanning path of a drone that scans the air to capture an image and displays a scanning path screen representing the scanning path.

### TECHNICAL FIELD

The present technology relates to an information processing method, an information processing apparatus, and a program, and more particularly, to an information processing method, an information processing apparatus, and a program capable of presenting a scanning path (scan-path) of an aerial imaging apparatus desired by a user.

### BACKGROUND ART

In recent years, it has become possible to easily perform aerial imaging by means of an unmanned aerial vehicle called a drone. As a method of generating a scanning path of the drone, for example, there is a method of generating a scanning path capable of efficiently moving on the basis of information of a target area (see, for example, Patent Document 1). As a method of generating the scanning path of the drone, there is also a method of generating a scanning path seik for scanning in the horizontal direction or a scanning path for scanning in the vertical direction.

Meanwhile, as a method of generating an automated driving scanning path of a work vehicle, there is a method of generating a reciprocating scanning path that repeats reciprocating travel in a field and a headland scanning path that travels along an outer peripheral shape of the field (see, for example, Patent Document 2).

### CITATION LIST

### Patent Document

Patent Document 1: WO 2020/090589 A

Patent Document 2: Japanese Patent Application Laid-Open No. 2022-048494

### Summary of the Invention

### Problems to be Solved by the Invention

However, there has not been proposed a method in which a user sets priority of conditions of a scanning path of an aerial imaging apparatus such as a drone. Therefore, it was difficult to present a desired scanning path of a user.

The present technology has been made in view of such a situation, and an object thereof is to present a scanning path of an aerial imaging apparatus desired by a user.

### Solutions to Problems

An information processing method according to one aspect of the present technology is an information processing method including: an imaging region-related information acquisition step of acquiring, by an imaging region-related information acquisition unit, imaging region-related information related to an imaging region desired of an aerial imaging apparatus; a condition acquisition step of acquiring, by a condition acquisition unit, priority of a condition of a scanning path of the aerial imaging apparatus; and a display control step of causing, by a display control unit, a display unit to display the scanning path on the basis of the imaging region-related information acquired by processing of the imaging region-related information acquisition step and the priority acquired by processing of the condition acquisition step.

An information processing apparatus or a program according to one aspect of the present technology is an information processing apparatus or a program for causing a computer to function as the information processing apparatus, the information processing apparatus including: an imaging region-related information acquisition unit that acquires imaging region-related information related to an imaging region desired of an aerial imaging apparatus; a condition acquisition unit that acquires priority of a condition of a scanning path of the aerial imaging apparatus; and a display control unit that causes a display unit to display the scanning path on the basis of the imaging region-related information acquired by the imaging region-related information acquisition unit and the priority acquired by the condition acquisition unit.

In one aspect of the present technology, imaging region-related information regarding a desired imaging region of an aerial imaging apparatus is acquired, priority of a condition of a scanning path of the aerial imaging apparatus is acquired, and the scanning path is displayed on a display unit on the basis of the imaging region-related information and the priority.

The information processing apparatus may be an independent apparatus or a module incorporated in another apparatus.

### BRIEF DESCRIPTION OF DRAWINGS

FIG. 1 is a block diagram illustrating a configuration example of an embodiment of an information treatment apparatus to which the present technology is applied.

FIG. 2 is a diagram illustrating an example of a mode selection screen.

FIG. 3 is a diagram illustrating an example of an imaging region-related information input screen.

FIG. 4 is a diagram illustrating an example of another imaging region-related information input screen.

FIG. 5 is a top view for explaining an example of generation of an imaging region.

FIG. 6 is a diagram illustrating an example of an imaging region input screen.

FIG. 7 is a diagram illustrating an example of a scanning information input screen.

FIG. 8 is a diagram for explaining an example of generation of a scanning path.

FIG. 9 is a diagram illustrating an example of a scanning path.

FIG. 10 is a diagram for explaining advantages of an elliptical or circular scanning region.

FIG. 11 is a diagram for explaining details of a spiral path.

FIG. 12 is a diagram for explaining details of a vertical zigzag path.

FIG. 13 is a diagram illustrating a first example of a priority input screen.

FIG. 14 is a diagram illustrating a second example of the priority input screen.

FIG. 15 is a diagram illustrating a first example of a scanning path screen.

FIG. 16 is a diagram illustrating a third example of the priority input screen.

FIG. 17 is a diagram illustrating a second example of the scanning path screen.

FIG. 18 is a diagram illustrating a fourth example of the priority input screen.

FIG. 19 is a diagram illustrating a third example of the scanning path screen.

FIG. 20 is a diagram illustrating a fourth example of the scanning path screen.

FIG. 21 is a first flowchart for explaining scanning path generation processing.

FIG. 22 is a second flowchart for explaining scanning path generation processing.

FIG. 23 is a block diagram illustrating a configuration example of hardware of a computer.

### MODE FOR CARRYING OUT THE INVENTION

Modes for carrying out the present technology (hereinafter, referred to as embodiments) will be described below. Note that the description will be given in the following order.
1. One Embodiment
2. Computer

### 1. One Embodiment

### Configuration Example of Information Processing Apparatus

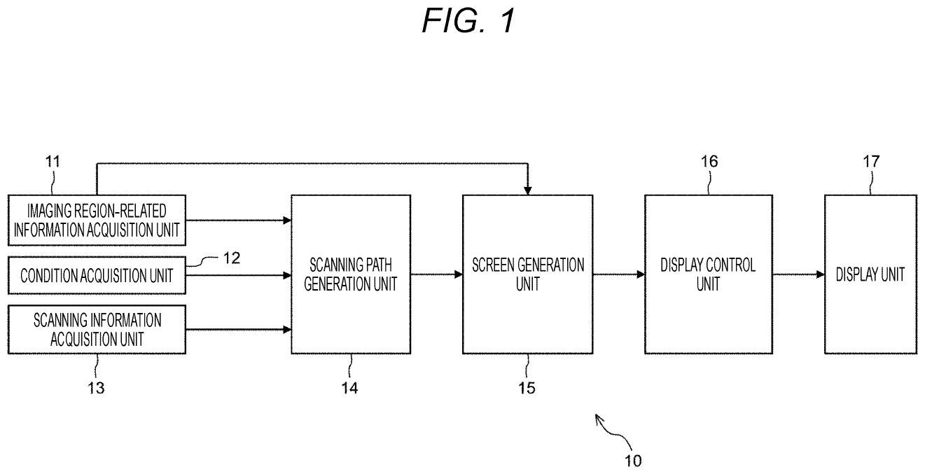

FIG. 1 is a block diagram illustrating a configuration example of an embodiment of an information treatment apparatus to which the present technology is applied.

The information processing apparatus 10 in FIG. 1 includes an imaging region-related information acquisition unit 11, a condition acquisition unit 12, a scanning information acquisition unit 13, a scanning path generation unit 14, a screen generation unit 15, a display control unit 16, and a display unit 17. The information processing apparatus 10 generates and displays a scanning path of a drone, which is an aerial imaging apparatus that performs imaging by scanning in the air.

Specifically, the imaging region-related information acquisition unit 11 acquires imaging region-related information regarding a desired imaging region of the drone input by the user. The imaging region-related information acquisition unit 11 generates an imaging region on the basis of the imaging region-related information and supplies the imaging region to the screen generation unit 15. The imaging region-related information acquisition unit 11 also supplies the imaging region to the scanning path generation unit 14 as necessary.

The condition acquisition unit 12 acquires the priority of the scanning path condition, which is various conditions of the scanning path of the drone input by the user, and supplies the priority to the scanning path generation unit 14.

The scanning information acquisition unit 13 acquires the scanning information including the scanning altitude indicating the height of the drone at the time of scanning and the imaging angle of view, the scan information being input by a user, and supplies the scanning information to the scanning path generation unit 14. Note that the scanning altitude and the imaging angle of view may be determined in advance instead of being input by the user. The reference position of the scanning altitude can be set at an arbitrary position. For example, the scanning altitude can represent a height from a ground surface (ground) on which the drone flies, a sea surface, or the like.

The scanning path generation unit 14 generates various scanning paths of the drone on the basis of the imaging region supplied from the imaging region-related information acquisition unit 11 and the scanning information supplied from the scanning information acquisition unit 13. The scanning path generation unit 14 selects an optimum scanning path from the generated scanning paths on the basis of the priority supplied from the condition acquisition unit 12, and supplies the same to the screen generation unit 15 as a scanning path desired by the user.

The screen generation unit 15 generates various screens as a user interface in accordance with input from the user or the like. For example, the screen generation unit 15 generates an imaging region-related information input screen for inputting imaging region-related information, a priority input screen for inputting priorities of various scanning path conditions, a scanning information input screen for inputting scanning information, and the like. On the basis of the imaging region supplied from the imaging region-related information acquisition unit 11, the screen generation unit 15 generates an imaging region input screen or the like for inputting the imaging region. On the basis of the scanning path supplied from the scanning path generation unit 14, the screen generation unit 15 generates a scanning path screen representing the scanning path. The screen generation unit 15 supplies the generated various screens to the display control unit 16.

The display control unit 16 controls the display unit 17 to display various screens supplied from the screen generation unit 15 on the display unit 17. The display unit 17 includes a display, a touch panel, and the like. The user performs a touch operation or an operation using an input unit such as a keyboard, a mouse, and an operation button (not illustrated) on various screens displayed on the display unit 17.

Note that each unit constituting the information processing apparatus 10 may be provided in one apparatus or in a plurality of apparatuses. For example, a part of the information processing apparatus 10 may be provided in a drone, and the other part may be provided in a control apparatus that controls the drone.

A part of the functions of the units constituting the information processing apparatus 10 may be provided in the drone, and other functions may be provided in the control apparatus that controls the drone. For example, some of the various screens displayed on the display unit 17 may be displayed on a display unit provided on the drone, and other screens may be displayed on a display unit provided on the control apparatus.

### Example of Mode Selection Screen

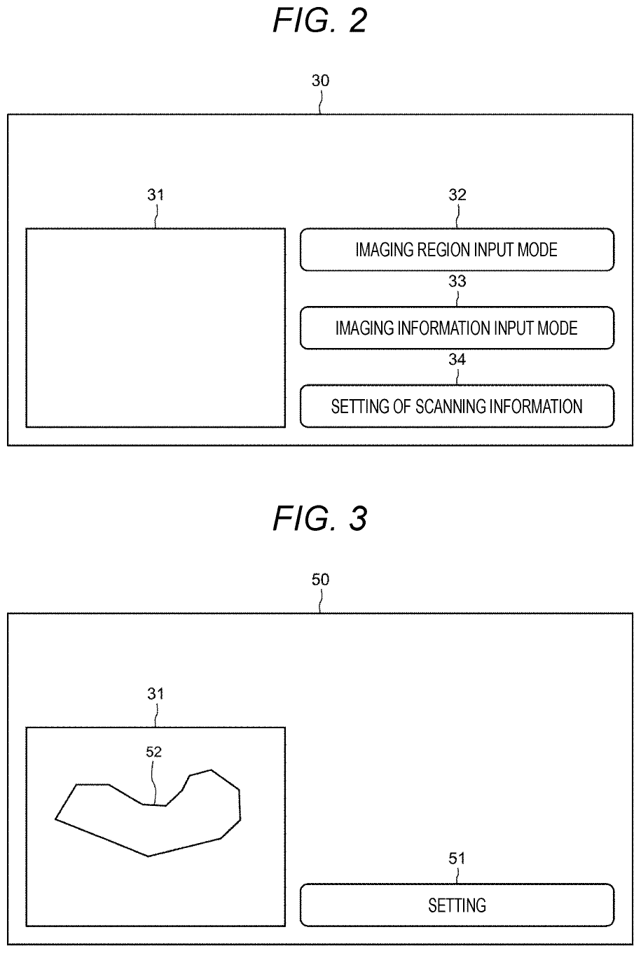

FIG. 2 is a diagram illustrating an example of a mode selection screen generated by the screen generation unit 15 in FIG. 1 to select an input mode of imaging region-related information.

The mode selection screen 30 of FIG. 2 includes an imaging area display unit 31, an imaging region input mode button 32, an imaging information input mode button 33, and a scanning information setting button 34.

The aerial image of the area including the imaging region desired by the user is displayed on the imaging area display unit 31. Note that a map or the like of an area including an imaging region desired by the user may be displayed on the imaging area display unit 31.

The imaging region input mode button 32 is operated by the user when selecting, as the input mode of the imaging region-related information, an imaging region input mode for inputting an imaging region desired by the user as the imaging region-related information.

The imaging information input mode button 33 is operated by the user when selecting, as an input mode of the imaging region-related information, an imaging information input mode for inputting a desired imaging path, imaging range angle, and imaging altitude of the user as the imaging region-related information. The imaging range angle is an angle in a horizontal direction and a vertical direction representing a desired imaging range of the user with respect to the drone at each point of the imaging path. The imaging altitude is the height of the drone from the ground at the time of imaging desired by the user.

Note that the imaging range angle input in the imaging information input mode may be information other than the imaging range angle as long as the information indicates the imaging range desired by the user. The imaging range angle may be determined in advance according to the type of drone. In this case, the user inputs only the imaging path and the imaging altitude.

The scanning information setting button 34 is operated by the user when the scanning information input screen is displayed.

### Example of Imaging Region-Related Information Input Screen in Imaging Region Input Mode

FIG. 3 is a diagram illustrating an example of the imaging region-related information input screen displayed when the user selects the imaging region input mode button 32 on the mode selection screen 30 of FIG. 2.

In the imaging region-related information input screen 50 of FIG. 3, a portion corresponding to the mode selection screen 30 of FIG. 2 is denoted by the same reference sign. Therefore, description of the portions is appropriately omitted, and description will be given focusing on portions different from the mode selection screen 30.

The imaging region-related information input screen 50 in FIG. 3 includes an imaging area display unit 31 and a setting button 51. The user designates the vertex of the imaging region of the desired polygon on the aerial image displayed on the imaging area display unit 31 on the imaging region-related information input screen 50. As a result, the imaging region information 52 indicating the imaging region is superimposed on the aerial image. In a case of inputting the imaging region indicated by the imaging region information 52 as the imaging region-related information, the user operates the setting button 51. As a result, the imaging region-related information acquisition unit 11 acquires the imaging region indicated by the imaging region information 52 as the imaging region-related information, and generates the imaging region.

### Example of Imaging Region-Related Information Input Screen in Imaging Information Input Mode

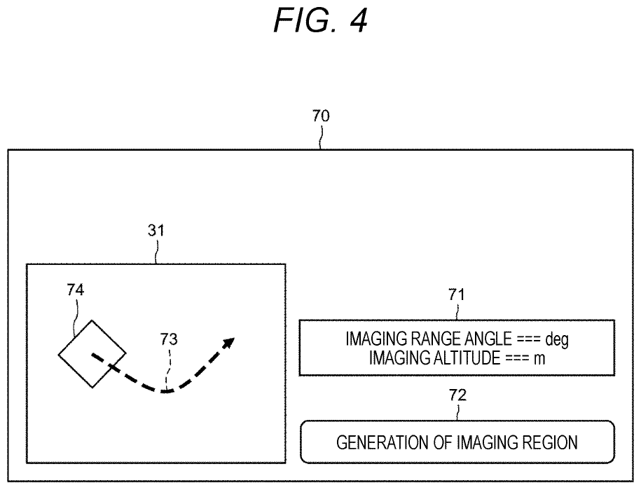

FIG. 4 is a diagram illustrating an example of the imaging region-related information input screen displayed when the imaging information input mode button 33 is selected by the user on the mode selection screen 30 of FIG. 2.

In the imaging region-related information input screen 70 of FIG. 4, a portion corresponding to the mode selection screen 30 of FIG. 2 is denoted by the same reference sign. Therefore, description of the portions is appropriately omitted, and description will be given focusing on portions different from the mode selection screen 30.

The imaging region-related information input screen 70 in FIG. 4 includes an imaging area display unit 31, an imaging range angle/imaging altitude input unit 71, and a generation button 72. The user designates a desired imaging path on the aerial image displayed on the imaging area display unit 31 on the imaging region-related information input screen 70. As a result, the imaging path information 73 indicating the imaging path is superimposed on the aerial image.

The user also inputs (designates) the imaging range angle [deg] and the imaging altitude [m] in the imaging range angle/imaging altitude input unit 71. As a result, the imaging range information 74 indicating the imaging range of the imaging start point in the aerial image displayed on the imaging area display unit 31 is superimposed on the aerial image on the basis of the imaging range angle and the imaging altitude.

In a case of inputting the imaging range angle and the imaging altitude input in the imaging range angle/imaging altitude input unit 71 and the imaging path indicated by the imaging path information 73 as the imaging region-related information, the user operates the generation button 72. As a result, the imaging region-related information acquisition unit 11 acquires the imaging range angle, the imaging altitude, and the imaging path as the imaging region-related information, and generates the imaging region on the basis of the imaging region-related information.

### Example of Generation of Imaging Region

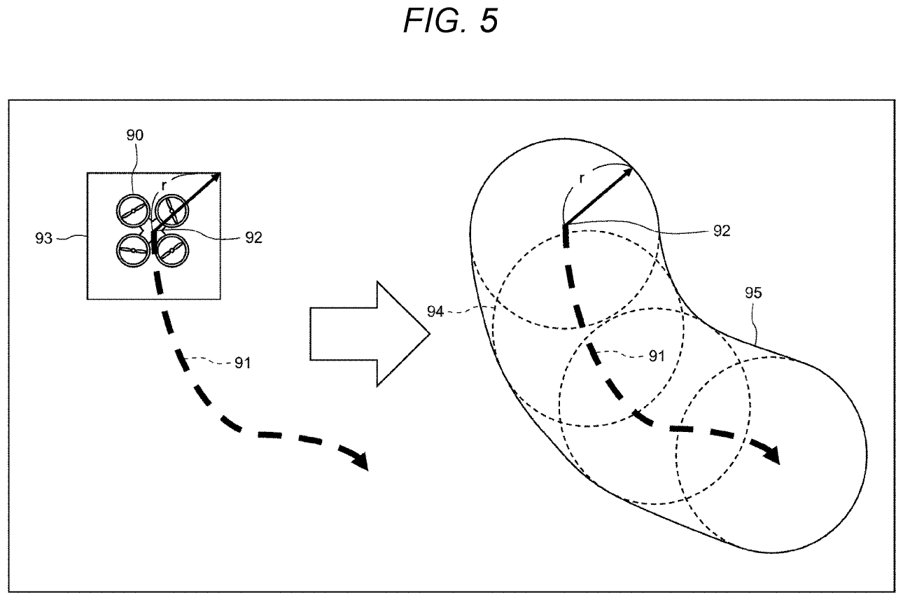

FIG. 5 is a top view illustrating an example of generation of the imaging region based on the imaging region-related information in the imaging information input mode by the imaging region-related information acquisition unit 11.

As illustrated on the left side of FIG. 5, the imaging region-related information acquisition unit 11 obtains the imaging range 93 at the imaging altitude of the imaging start point 92 of the imaging path 91 on the basis of the imaging range angle and the imaging altitude in the imaging region-related information of the drone 90. The imaging region-related information acquisition unit 11 obtains the distance r between the center of the drone 90 and the position farthest from the center in the imaging range 93, that is, ½ of the length of the diagonal line of the imaging range 93.

Then, as illustrated on the right side of FIG. 5, the imaging region-related information acquisition unit 11 generates, as the imaging region 95, the minimum region including the locus of the circumscribed circle 94 of the imaging range 93 having the distance r at each point of the imaging path 91 as the radius, that is, the circumscribed circle 94 whose center moves on the imaging path 91.

### Example of Imaging Region Input Screen in Imaging Information Input Mode

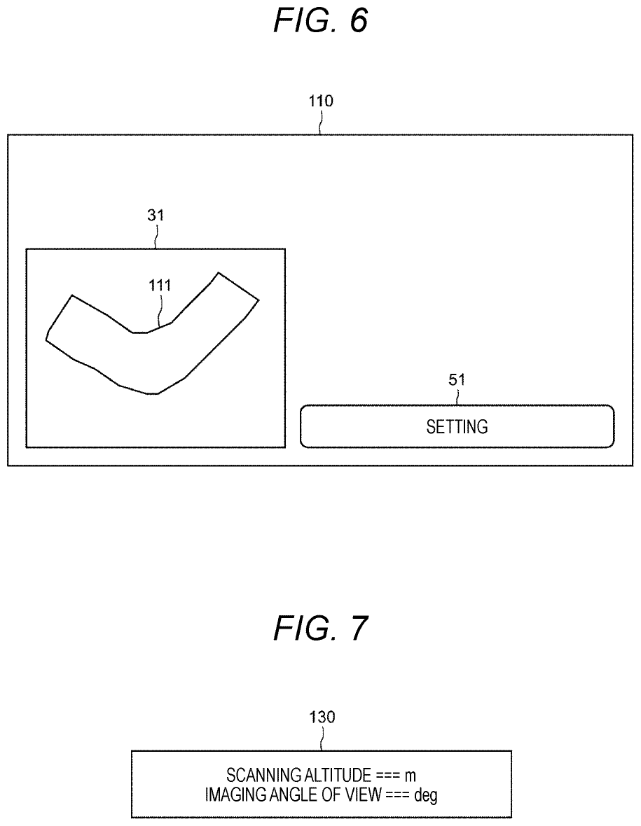

FIG. 6 is a diagram illustrating an example of the imaging region input screen displayed when the generation button 72 is selected by the user on the imaging region-related information input screen 70 in FIG. 4.

In the imaging region input screen 110 of FIG. 6, portions corresponding to those in the imaging region-related information input screen 50 of FIG. 3 are denoted by the same reference signs. Therefore, description of the portions is appropriately omitted, and description will be given focusing on portions different from the imaging region-related information input screen 50.

The imaging region input screen 110 in FIG. 6 is different from the imaging region-related information input screen 50 in that the imaging region information 52 is replaced with the imaging region information 111 indicating the imaging region generated by the imaging region-related information acquisition unit 11. The other configurations are similar to those of the imaging region-related information input screen 50.

### Example of Scanning Information Input Screen

FIG. 7 is a diagram illustrating an example of a scanning information input screen displayed when the scanning information setting button 34 is operated on the mode selection screen 30 of FIG. 2.

On a scanning information input screen 130 in FIG. 7, a scanning altitude [m] and an imaging angle of view [deg] can be input. The scanning information acquisition unit 13 acquires the scanning altitude [m] and the imaging angle of view [deg] input by the user on the scanning information input screen 130 as the scanning information.

### Example of Generation of Scanning Path

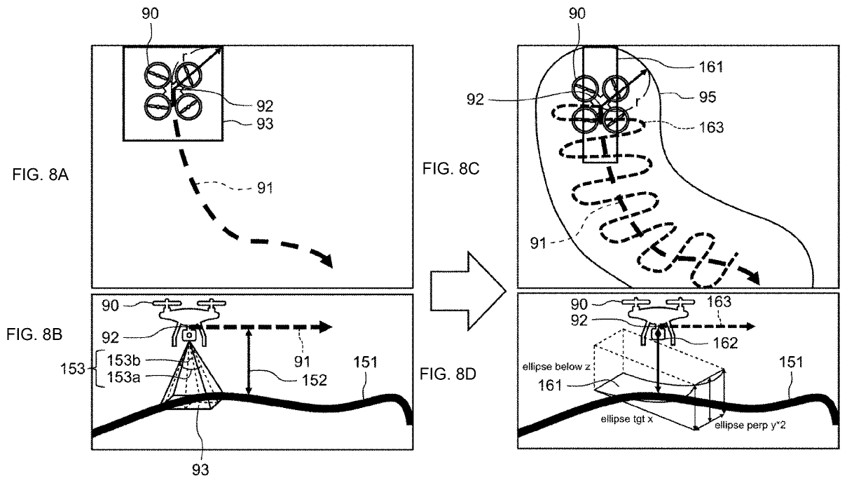

FIG. 8 is a diagram for explaining an example of generation of a scanning path by the scanning path generation unit 14 in FIG. 1.

In FIG. 8, portions corresponding to those in FIG. 5 are denoted by the same reference signs. Therefore, description of the portions is appropriately omitted, and description will be given focusing on portions different from FIG. 5.

A and C of FIG. 8 are views of the drone 90 as viewed from above, and B and D of FIG. 8 are views of the drone 90 as viewed from the side.

In a case of inputting the imaging region-related information in the imaging information input mode, the user inputs the imaging path 91 of the drone 90 illustrated in A and B of FIG. 8, the imaging altitude 152 that is the height from the ground 151, and the imaging range angle 153. Note that the imaging range angle 153 includes a horizontal angle 153a and a vertical angle 153b. The shape of the ground 151 is unknown.

As described with reference to FIG. 5, the imaging region-related information acquisition unit 11 obtains the imaging range 93 on the basis of the imaging altitude 152 and the imaging range angle 153, and generates the imaging region 95 illustrated in C of FIG. 8 on the basis of the distance r of the imaging range 93.

The user also inputs, on the scanning information input screen 130, the imaging angle of view 161 illustrated in C and D of FIG. 8 and the scanning altitude 162 illustrated in D of FIG. 8 as the scanning information. On the basis of the scanning information and imaging region 95, the scanning path generation unit 14 generates the scanning path 163 according to a predetermined algorithm such that the scanning region that is actually scanned and captured by the drone 90 includes the imaging region 95.

### Example of Scanning Path

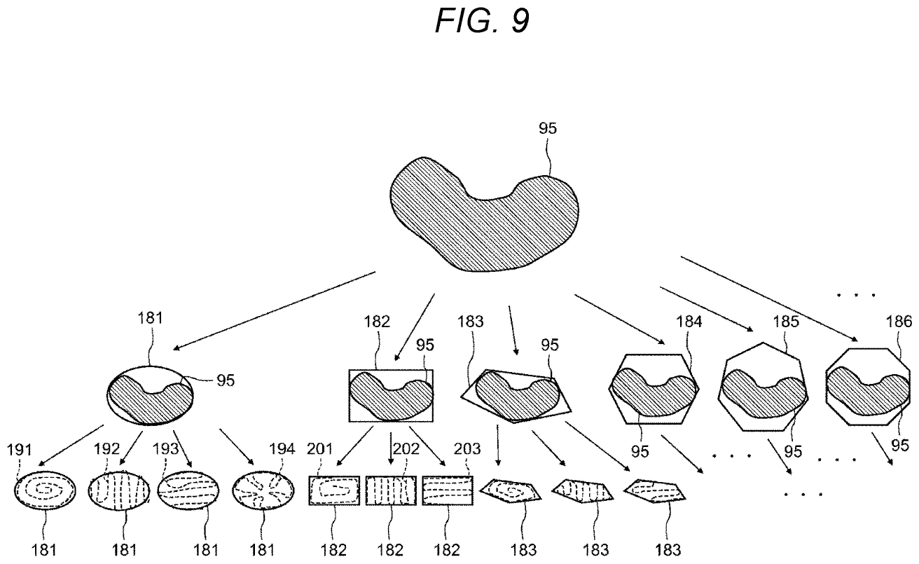

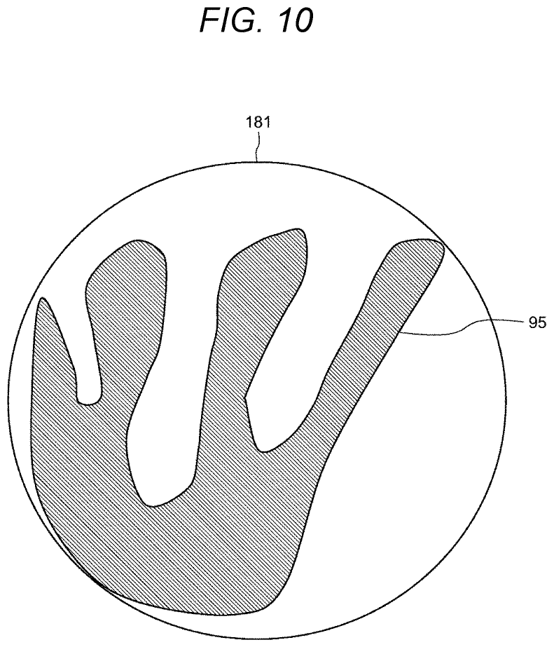

FIG. 9 is a diagram illustrating an example of the scanning path 163.

In FIG. 9, portions corresponding to those in FIG. 8 are denoted by the same reference signs.

As illustrated in FIG. 9, the scanning path generation unit 14 sets a minimum region of various shapes including (encapsulated in) the imaging region 95 as the scanning region.

For example, the scanning path generation unit 14 sets an elliptical or circular scanning region 181, a rectangular scanning region 182, a pentagonal scanning region 183, a hexagonal scanning region 184, a heptagonal scanning region 185, an octagonal scanning region 186, and the like.

The scanning path generation unit 14 also generates various scanning paths on the basis of the scanning regions 181 to 186. For example, the scanning path generation unit 14 generates, as the scanning path 163, a spiral path 191 that turns around the scanning region 181 so as to approach the center from the circumference.

The scanning path generation unit 14 generates, as the scanning path 163, a vertical zigzag path 192 that moves vertically zigzag from the left side to the right side of the scanning region 181 and a horizontal zigzag path 193 that moves horizontally zigzag from the upper side to the lower side. The scanning path generation unit 14 generates, as a scanning path 163, a path 194 that moves in zigzag along the center and circumference of the scanning region 181.

Similarly, the scanning path generation unit 14 generates a spiral path 201, a vertical zigzag path 202, and a horizontal zigzag path 203 as the scanning path 163 on the basis of the scanning region 182. Similarly, for the scanning regions 183 to 186, the scanning path generation unit 14 generates various scanning paths.

### Description of Advantages of Elliptical or Circular Scanning Region

FIG. 10 is a diagram for explaining the advantages of the elliptical or circular scanning region 181 of FIG. 9.

In a case of setting the elliptical or circular scanning region 181, the scanning path generation unit 14 can set the scanning region 181 for the imaging region 95 having an arbitrary shape. That is, as illustrated in FIG. 10, even in a case where the shape of the imaging region 95 is a complicated shape, the scanning region 181 can be set.

### Detailed Description of Scanning Path

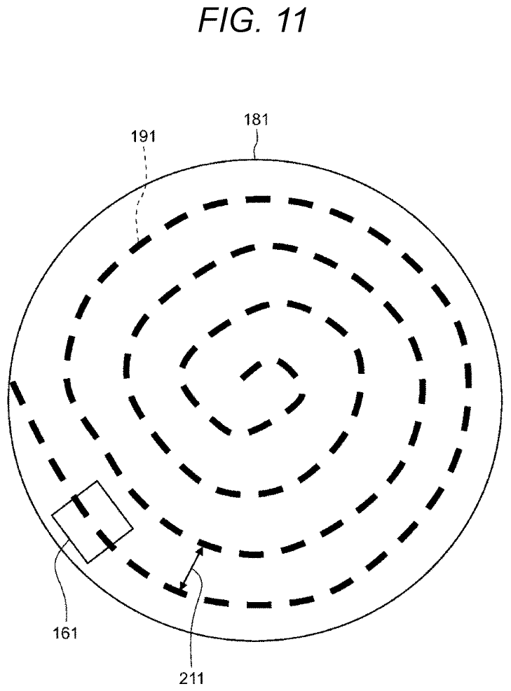

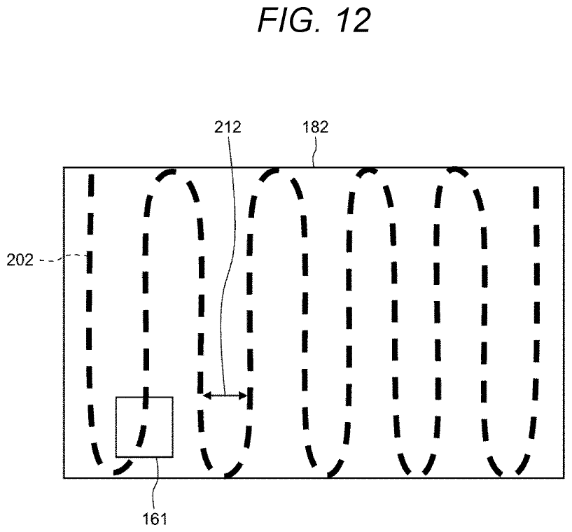

FIG. 11 is a diagram for explaining details of the spiral path 191, and FIG. 12 is a diagram for explaining details of the vertical zigzag path 202.

As illustrated in FIG. 11, in a case where the scanning path generation unit 14 generates the spiral path 191 as the scanning path 163, a path width 211, which is an interval between two paths 191 adjacent in the radial direction in the path 191, is determined on the basis of the imaging angle of view 161. For example, the path width 211 is determined such that the imaging angle of view 161 of each point of the path 191 overlaps with the imaging angle of view 161 of another point at a minimum.

As illustrated in FIG. 12, in a case where the scanning path generation unit 14 generates the vertical zigzag path 202 as the scanning path 163, the path width 212 between two paths 202 adjacent in the horizontal direction (left-right direction) in the path 202 is determined on the basis of the imaging angle of view 161. For example, the path width 212 is determined such that the imaging angle of view 161 of each point of the path 202 overlaps with the imaging angle of view 161 of another point at a minimum.

Although not illustrated, the path width is similarly determined on the basis of the imaging angle of view 161 for the vertical zigzag path 192 and the horizontal zigzag path 193 (203).

### First Example of Priority Input Screen

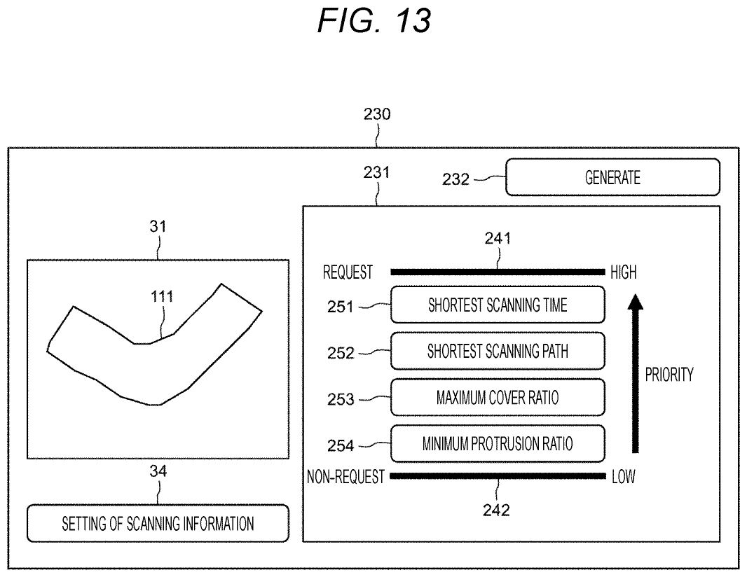

FIG. 13 is a diagram illustrating an example of a priority input screen displayed when the setting button 51 is operated by the user.

In the priority input screen 230 of FIG. 13, portions corresponding to the mode selection screen 30 of FIG. 2 and the imaging region input screen 110 of FIG. 6 are denoted by the same reference signs. Therefore, description of the portions is appropriately omitted, and description will be given focusing on portions different from the mode selection screen 30 and the imaging region input screen 110.

The priority input screen 230 in FIG. 13 includes an imaging area display unit 31 on which the aerial image on which the imaging region information 111 is superimposed is displayed, a scanning information setting button 34, a priority input unit 231, and a generation button 232.

In the priority input unit 231, a request line 241 is displayed at an upper portion, and a non-request line 242 is displayed at a lower portion. The priority input unit 231 also displays scanning path condition information indicating scanning path conditions.

Specifically, in the example of FIG. 13, between the request line 241 and the non-request line 242, the shortest scanning time information 251, the shortest scanning path information 252, the maximum cover ratio information 253, and the minimum protrusion ratio information 254 are displayed in order from the top as the scanning path condition information.

The shortest scanning time information 251 represents a shortest scanning time condition that is a scanning path condition that the scanning time is the shortest, and the shortest scanning path information 252 represents a shortest scanning path condition that is a scanning path condition that the distance of the scanning path is the shortest. The maximum cover ratio information 253 represents a maximum cover ratio condition that is a condition that the ratio of the scanning region in the imaging region represented by the imaging region information 111 is the largest. The minimum protrusion ratio information 254 represents a minimum protrusion ratio condition that is a condition that the ratio of a region other than the imaging region indicated by the imaging region information 111 in the scanning region is the smallest.

The user inputs the priority of each scanning path condition by arranging the scanning path condition information from the top in order from the scanning path condition information indicating the scanning path condition with high priority on the basis of the use of the image captured by the drone 90 in the application and the like.

Specifically, the user arranges the information indicating the scanning path condition that is necessarily required to be satisfied at the time of determining the desired scanning path among the scanning path condition information on the request line 241 in descending order of priority. The user arranges the information indicating the scanning path condition that is not required to be satisfied at the time of determining the desired scanning path among the scanning path condition information below the non-request line 242 in descending order of priority.

Between the request line 241 and the non-request line 242, the user arranges, from the top in descending order of priority, information indicating a scanning path condition that is preferably satisfied but not necessarily required to be satisfied at the time of determining a desired scanning path among the scanning path condition information.

As described above, the user inputs the priority of each scanning path condition by arranging the scanning path condition information from the top in descending order of priority in the priority input unit 231.

The generation button 232 is operated by the user when the priority of each scanning path condition input in the priority input unit 231 is input and a scanning path is generated on the basis of the priority. When the user operates the generation button 232, the condition acquisition unit 12 acquires the priority of each scanning path condition input by the user in the priority input unit 231.

### Second Example of Priority Input Screen

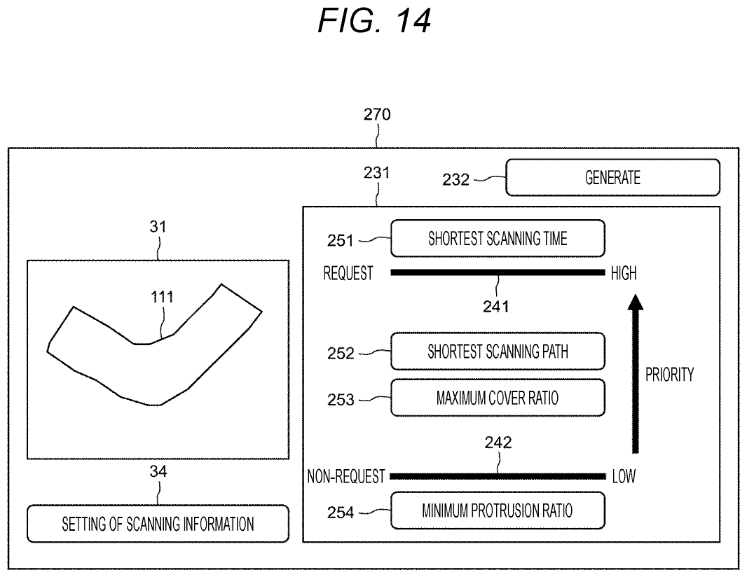

FIG. 14 is a diagram illustrating a first example of the priority input screen when the arrangement of the scanning path condition information is changed in the priority input unit 231 of FIG. 13.

In the priority input screen 270 of FIG. 14, portions corresponding to those of the priority input screen 230 of FIG. 13 are denoted by the same reference signs. Therefore, description of the portions is appropriately omitted, and description will be given focusing on portions different from the priority input screen 230.

In the example of FIG. 14, the imaging area is an area without the flight restriction of the drone 90, but the scanning time of the drone 90 is limited. Therefore, the scanning path condition that is necessarily required to be satisfied at the time of determining the scanning path desired by the user is the shortest scanning time condition, and the scanning path condition that does not need to be satisfied is the minimum protrusion ratio condition. Therefore, the user arranges the shortest scanning time information 251 above the request line 241 and arranges the minimum protrusion ratio information 254 below the non-request line 242.

In the example of FIG. 14, the priority of the scanning path conditions that are preferably satisfied but not necessarily required to be satisfied at the time of determining a desired scanning path are, in descending order of priority, the shortest scanning path condition and the maximum cover ratio condition. Therefore, the user arranges the shortest scanning path information 252 and the maximum cover ratio information 253 in order from the top between the request line 241 and the non-request line 242.

As described above, in the example of FIG. 14, the priority of the scanning path condition that is the highest and necessarily required to be satisfied is input as the priority of the shortest scanning time condition. As the priority of the shortest scanning path condition, the priority of the scanning path condition that is the second highest and is preferably satisfied but not necessarily required to be satisfied is input. As the priority of the maximum cover ratio condition, the priority of the scanning path condition that is the third highest and is preferably satisfied but not necessarily required to be satisfied is input. As the priority of the minimum protrusion ratio condition, the priority of the scanning path condition that is the fourth highest and does not need to be satisfied is input.

Therefore, for each generated scanning path, the scanning path generation unit 14 calculates the scanning time corresponding to the scanning path on the basis of the speed of the drone 90, and selects the scanning path with the shortest scanning time. Note that, in a case where there is a plurality of scanning paths having the shortest scanning time, the scanning path generation unit 14 calculates the distance of the scanning path and selects the scanning path having the shortest distance. In a case where there is a plurality of scanning paths having the shortest scanning distance, the scanning path generation unit 14 calculates the ratio of the scanning region corresponding to the scanning path in the imaging region, and selects the scanning path having the largest ratio. In a case where there is a plurality of scanning paths having the largest ratio, the scanning path generation unit 14 selects an arbitrary scanning path from the scanning paths.

### First Example of Scanning Path Screen

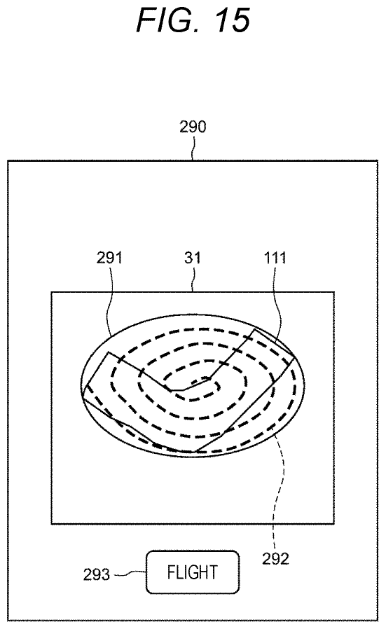

FIG. 15 is a diagram illustrating an example of a scanning path screen displayed when the user operates the generation button 232 on the priority input screen 270 of FIG. 14.

In the scanning path screen 290 of FIG. 15, portions corresponding to those of the priority input screen 270 of FIG. 14 are denoted by the same reference signs. Therefore, description of the portions is appropriately omitted, and description will be given focusing on portions different from the priority input screen 270.

The scanning path screen 290 of FIG. 15 includes an imaging area display unit 31. On the aerial image displayed on the imaging area display unit 31 of the scanning path screen 290, not only the imaging region information 111 but also the scanning region information 291 indicating the scanning region and the scanning path information 292 indicating the scanning path are superimposed. The scanning region information 291 indicates a scanning region corresponding to a scanning path selected by the scanning path generation unit 14 on the basis of the priority of each scanning path condition input by the priority input unit 231, and the scanning path information 292 is information indicating the scanning path.

In the example of FIG. 15, the scanning path condition that is necessarily required to be satisfied at the time of determining the scanning path desired by the user is the shortest scanning time condition. Therefore, in the example of FIG. 15, a spiral scanning path that does not need to change the direction causing the decrease in speed of the drone 90 is selected. As a result, the scanning region information 291 represents, for example, an elliptical or circular scanning region, and the scanning path information 292 represents a spiral scanning path.

The scanning path screen 290 also includes a flight button 293. The flight button 293 is operated by the user when causing the drone 90 to scan along the scanning path indicated by the scanning path information 292 and capture an image.

### Third Example of Priority Input Screen

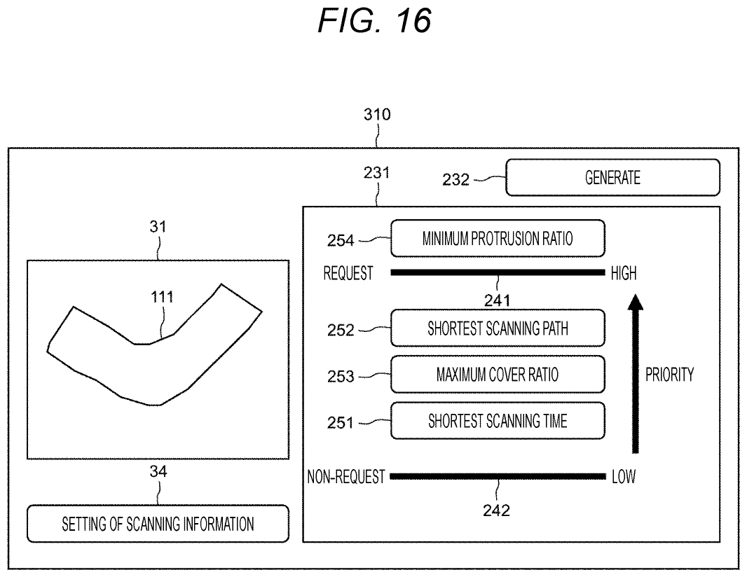

FIG. 16 is a diagram illustrating a second example of the priority input screen when the arrangement of the scanning path condition information is changed on the priority input screen 230 of FIG. 13.

In the priority input screen 310 of FIG. 16, portions corresponding to those of the priority input screen 230 of FIG. 13 are denoted by the same reference signs. Therefore, description of the portions is appropriately omitted, and description will be given focusing on portions different from the priority input screen 230.

In the example of FIG. 16, the imaging area is an area with a flight restriction of the drone 90 such as a public place, and the imaging region is set in a region where the flight of the drone 90 is permitted. Therefore, the scanning path condition that is necessarily required to be satisfied at the time of determining the scanning path desired by the user is the minimum protrusion ratio condition. Therefore, the user arranges the minimum protrusion ratio information 254 on the request line 241.

On the other hand, in the example of FIG. 16, there is no scanning path condition that does not need to be satisfied at the time of determining a desired scanning path. Therefore, the user does not arrange any scanning path condition information under the non-request line 242.

In the example of FIG. 16, the priority of the scanning path condition that is preferably satisfied but not necessarily required to be satisfied at the time of determining the desired scanning path is the shortest scanning path condition, the maximum cover ratio condition, and the shortest scanning time condition in descending order. Therefore, the user arranges the shortest scanning path information 252, the maximum cover ratio information 253, and the shortest scanning time information 251 in order from the top between the request line 241 and the non-request line 242.

As described above, in the example of FIG. 16, the priority of the scanning path condition that is the highest and necessarily required to be satisfied is input as the priority of the minimum protrusion ratio condition. As the priority of the shortest scanning path condition, the priority of the scanning path condition that is the second highest and is preferably satisfied but not necessarily required to be satisfied is input. As the priority of the maximum cover ratio condition, the priority of the scanning path condition that is the third highest and is preferably satisfied but not necessarily required to be satisfied is input. As the priority of the shortest scanning time condition, the priority of the scanning path condition that is the fourth highest and is preferably satisfied but not necessarily required to be satisfied is input.

Therefore, for each generated scanning path, the scanning path generation unit 14 calculates a ratio of a region other than the imaging region in the scanning region corresponding to the scanning path, and selects the scanning path having the smallest ratio. Note that, in a case where there is a plurality of scanning paths having the smallest ratio, the scanning path generation unit 14 calculates the distance of the scanning path and selects the scanning path having the shortest distance. In a case where there is a plurality of scanning paths having the shortest scanning distance, the scanning path generation unit 14 calculates the ratio of the scanning region corresponding to the scanning path in the imaging region, and selects the scanning path having the largest ratio. In a case where there is a plurality of scanning paths having the largest ratio, the scanning path generation unit 14 calculates a scanning time corresponding to the scanning path on the basis of the speed of the drone 90, and selects a scanning path having the shortest scanning time. In a case where there is a plurality of scanning paths having the shortest scanning time, the scanning path generation unit 14 selects an arbitrary scanning path from the scanning paths.

### Second Example of Scanning Path Screen

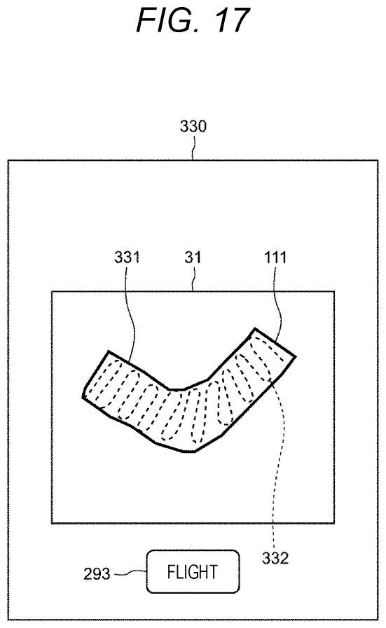

FIG. 17 is a diagram illustrating an example of a scanning path screen displayed when the user operates the generation button 232 on the priority input screen 310 of FIG. 16.

Portions of the scanning path screen 330 of FIG. 17 corresponding to those of the scanning path screen 290 of FIG. 15 are denoted by the same reference signs. Therefore, description of the portions is appropriately omitted, and description will be given focusing on portions different from the scanning path screen 290.

The scanning path screen 330 of FIG. 17 is different from the scanning path screen 290 in that the scanning region information 291 and the scanning path information 292 are replaced with the scanning region information 331 and the scanning path information 332, respectively, and is configured similarly to the scanning path screen 290 except for this.

In the example of FIG. 17, the scanning path condition that is necessarily required to be satisfied when determining the scanning path desired by the user is the minimum protrusion ratio condition. Therefore, in the example of FIG. 17, the scanning path corresponding to the scanning region set to be the same as the imaging region is selected. As a result, the scanning region information 331 is the same as the imaging region information 111, and the scanning path information 332 represents a scanning path that does not protrude from the imaging region represented by the imaging region information 111.

### Fourth Example of Priority Input Screen

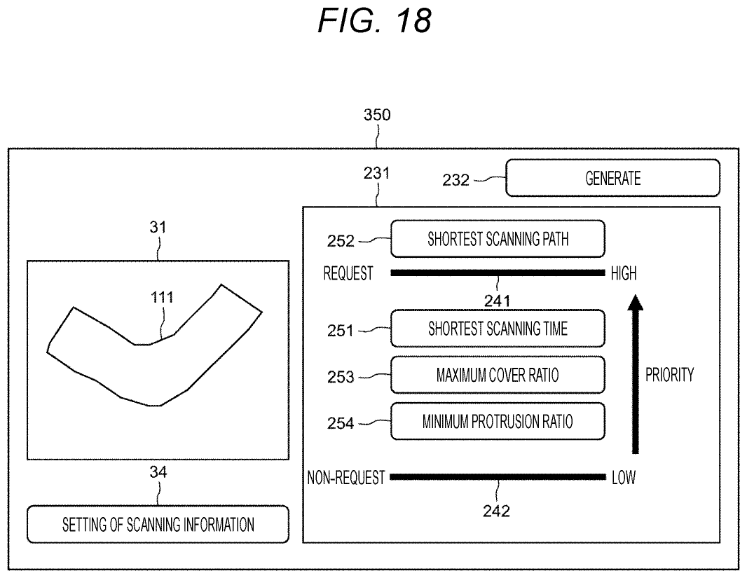

FIG. 18 is a diagram illustrating a third example of the priority input screen when the arrangement of the scanning path condition information is changed on the priority input screen 230 of FIG. 13.

In the priority input screen 350 of FIG. 18, portions corresponding to those of the priority input screen 230 of FIG. 13 are denoted by the same reference signs. Therefore, description of the portions is appropriately omitted, and description will be given focusing on portions different from the priority input screen 230.

In the example of FIG. 18, the scanning path condition that is necessarily required to be satisfied when determining the scanning path desired by the user is the shortest scanning path. Therefore, the user arranges the shortest scanning path information 252 on the request line 241. In the example of FIG. 18, there is no scanning path condition that does not need to be satisfied at the time of determining a desired scanning path. Therefore, no scanning path condition information is arranged below the non-request line 242.

In the example of FIG. 18, the priority of the scanning path condition that is preferably satisfied but not necessarily required to be satisfied at the time of determining the desired scanning path is the shortest scanning time condition, the maximum cover ratio condition, and the minimum protrusion ratio condition in descending order. Therefore, the user arranges the shortest scanning time information 251, the maximum cover ratio information 253, and the minimum protrusion ratio information 254 in order from the top between the request line 241 and the non-request line 242.

As described above, in the example of FIG. 18, as the priority of the shortest scanning path condition, the priority of the scanning path condition that is the highest and necessarily required to be satisfied is input. As the priority of the shortest scanning time condition, the priority of the scanning path condition that is the second highest and is preferably satisfied but not necessarily required to be satisfied is input. As the priority of the maximum cover ratio condition, the priority of the scanning path condition that is the third highest and is preferably satisfied but not necessarily required to be satisfied is input. As the priority of the minimum protrusion ratio condition, the priority of the scanning path condition that is the fourth highest and is preferably satisfied but not necessarily required to be satisfied is input.

Therefore, the scanning path generation unit 14 calculates the distance of the scanning path for each generated scanning path, and selects the scanning path having the shortest distance. Note that, in a case where there is a plurality of scanning paths having the shortest scanning distance, the scanning path generation unit 14 calculates a scanning time corresponding to the scanning path on the basis of the speed of the drone 90, and selects a scanning path having the shortest scanning time. In a case where there is a plurality of scanning paths having the shortest scanning time, the scanning path generation unit 14 calculates a ratio of a scanning region corresponding to the scanning path in the imaging region, and selects a scanning path having the largest ratio. In a case where there is a plurality of scanning paths having the largest ratio, the scanning path generation unit 14 calculates the ratio of the region other than the imaging region in the scanning region corresponding to the scanning path, and selects the scanning path having the smallest ratio. In a case where there is a plurality of scanning paths having the smallest ratio, the scanning path generation unit 14 selects an arbitrary scanning path from the scanning paths.

### Third Example of Scanning Path Screen

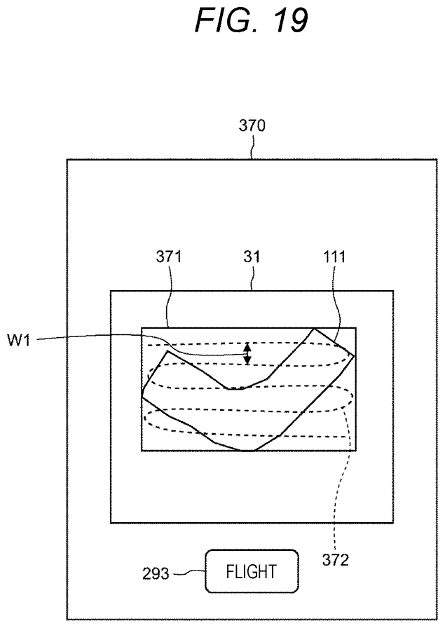

FIG. 19 is a diagram illustrating a first example of the scanning path screen displayed when the user operates the generation button 232 on the priority input screen 350 in FIG. 18.

Portions of the scanning path screen 370 of FIG. 19 corresponding to those of the scanning path screen 290 of FIG. 15 are denoted by the same reference signs. Therefore, description of the portions is appropriately omitted, and description will be given focusing on portions different from the scanning path screen 290.

The scanning path screen 370 of FIG. 19 is different from the scanning path screen 290 in that the scanning region information 291 and the scanning path information 292 are replaced with the scanning region information 371 and the scanning path information 372, respectively, and is configured similarly to the scanning path screen 290 except for this.

In the example of FIG. 19, the scanning path condition that is necessarily required to be satisfied at the time of determining the scanning path desired by the user is the shortest scanning path condition. Therefore, in the example of FIG. 19, the horizontal zigzag scanning paths corresponding to the rectangular scanning region are selected. As a result, the scanning region information 371 represents a rectangular scanning region, and the scanning path information 372 represents a horizontal zigzag scanning path.

### Fourth Example of Scanning Path Screen

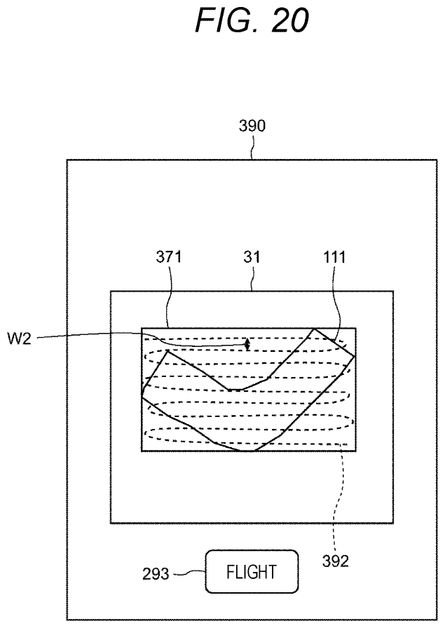

FIG. 20 is a diagram illustrating a second example of the scanning path screen displayed when the user operates the generation button 232 on the priority input screen 350 in FIG. 18.

Portions of the scanning path screen 390 of FIG. 20 corresponding to those of the scanning path screen 370 of FIG. 19 are denoted by the same reference signs. Therefore, description of the portions is appropriately omitted, and description will be given focusing on portions different from the scanning path screen 370.

The scanning path screen 390 of FIG. 20 is different from the scanning path screen 370 in that the scanning path information 372 is replaced with the scanning path information 392, and is configured similarly to the scanning path screen 370 in other respects.

In the example of FIG. 20, the scanning altitude is twice the scanning altitude of the example of FIG. 19, and the imaging angle of view is the same as the imaging angle of view of the example of FIG. 19. Therefore, the path width W2 between pieces of information indicating two paths adjacent in the vertical direction in the scanning path information 392 is ½ of the path width W1 between pieces of information indicating two paths adjacent in the vertical direction in the scanning path information 372 of FIG. 19.

Although not illustrated, for example, in a case where the imaging area is an area where there is no flight restriction of the drone 90 and there is no restriction on the scanning time, the user arranges, for example, the maximum cover ratio information 253 on the request line 241. As a result, as the priority of the maximum cover ratio condition, the priority of the scanning path condition that is the highest and necessarily required to be satisfied is input.

### Description of Scanning Path Generation Processing

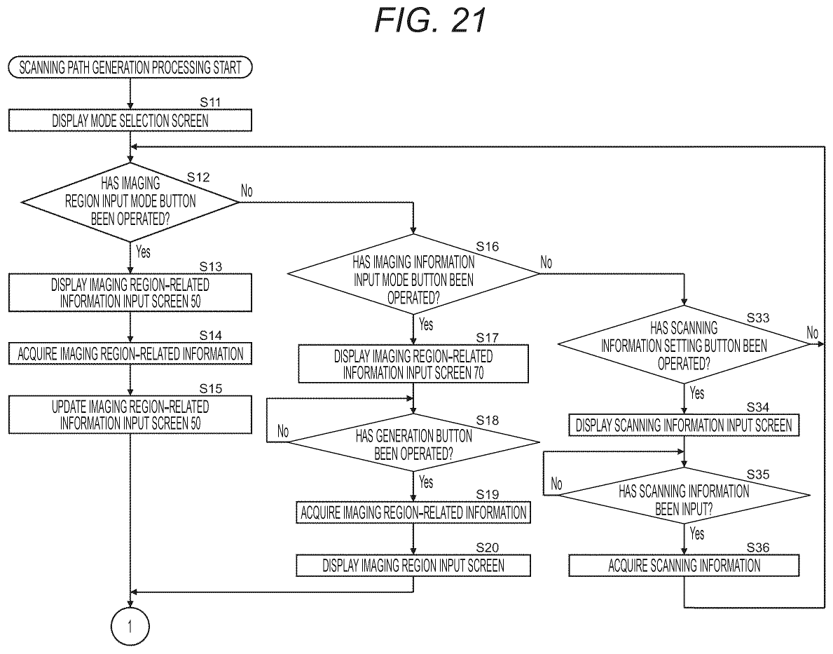

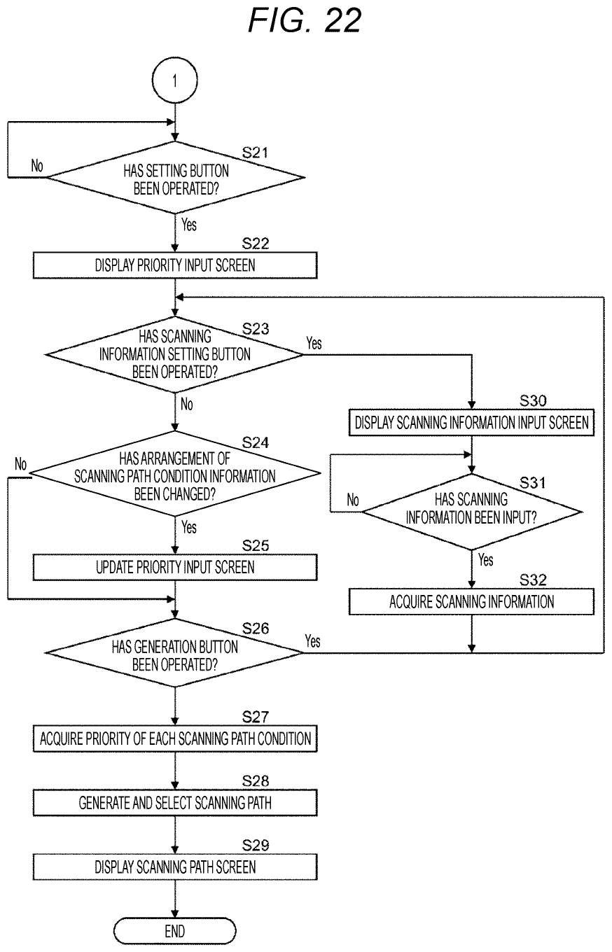

FIGS. 21 and 22 are flowcharts for explaining scanning path generation processing for determining a scanning path by the information processing apparatus 10. This scanning path generation processing is started, for example, when the user instructs generation of the scanning path of the drone 90.

In step S11 of FIG. 21, the display control unit 16 causes the display unit 17 to display the mode selection screen 30 generated by the screen generation unit 15.

In step S12, the screen generation unit 15 determines whether or not the imaging region input mode button 32 is operated by the user on the mode selection screen 30 displayed by the processing in step S11. In a case where it is determined in step S12 that the imaging region input mode button 32 has been operated, the screen generation unit 15 generates the imaging region-related information input screen 50 in FIG. 3 on which the imaging region information 52 is not yet superimposed and supplies the imaging region-related information input screen 50 to the display control unit 16, and the processing proceeds to step S13.

In step S13, the display control unit 16 causes the display unit 17 to display the imaging region-related information input screen 50 supplied from the screen generation unit 15. At this time, the user designates a vertex of a desired imaging region on the aerial image displayed on the imaging area display unit 31 of the imaging region-related information input screen 50.

In step S14, the imaging region-related information acquisition unit 11 acquires the imaging region designated by the user on the imaging region-related information input screen 50 displayed by the processing in step S13 as the imaging region-related information, and supplies the imaging region to the screen generation unit 15. The screen generation unit 15 generates an imaging region-related information input screen 50 in which the imaging region information 52 indicating the imaging region is superimposed on the aerial image, as an updated imaging region-related information input screen 50, and supplies the same to the display control unit 16.

In step S15, the display control unit 16 updates the imaging region-related information input screen 50 by displaying the imaging region-related information input screen 50 on the display unit 17. Then, the processing proceeds to step S21 in FIG. 22.

On the other hand, in a case where it is determined in step S12 that the imaging region input mode button 32 is not operated, the processing proceeds to step S16.

In step S16, the screen generation unit 15 determines whether or not the imaging information input mode button 33 is operated by the user on the mode selection screen 30 displayed by the processing in step S11. In a case where it is determined in step S16 that the imaging information input mode button 33 has been operated, the screen generation unit 15 generates the imaging region-related information input screen 70 in FIG. 4 on which the imaging path information 73 and the imaging range information 74 are not yet superimposed, and supplies the imaging region-related information input screen 70 to the display control unit 16. Then, the processing proceeds to step In step S17, the display control unit 16 causes the display unit 17 to display the imaging region-related information input screen 70 supplied from the screen generation unit 15. At this time, the user designates a desired imaging path on the aerial image displayed on the imaging area display unit 31 of the imaging region-related information input screen 70, and designates the imaging range angle [deg] and the imaging altitude [m] in the imaging range angle/imaging altitude input unit 71.

In step S18, the imaging region-related information acquisition unit 11 determines whether or not the generation button 72 has been operated. In a case where it is determined in step S18 that the generation button 72 is not operated, the imaging region-related information acquisition unit 11 waits until the generation button 72 is operated.

On the other hand, in a case where it is determined in step S18 that the generation button 72 has been operated, the processing proceeds to step S19.

In step S19, the imaging region-related information acquisition unit 11 acquires, as the imaging region-related information, the imaging range angle, the imaging altitude, and the imaging path designated by the user on the imaging region-related information input screen 70 displayed by the processing in step S17. Then, the imaging region-related information acquisition unit 11 generates the imaging region on the basis of the imaging region-related information, and supplies the imaging region to the screen generation unit 15. The screen generation unit 15 generates the imaging region input screen 110 in FIG. 6 on the basis of the imaging region, and supplies the imaging region input screen to the display control unit 16.

In step S20, the display control unit 16 causes the display unit 17 to display the imaging region input screen 110 supplied from the screen generation unit 15, and advances the processing to step S21 in FIG. 22.

In step S21 of FIG. 22, the imaging region-related information acquisition unit 11 determines whether or not the setting button 51 is operated. In a case where it is determined in step S21 that the setting button 51 has not been operated yet, the imaging region-related information acquisition unit 11 waits until the setting button 51 is operated.

In a case where it is determined in step S21 that the setting button 51 has been operated, the imaging region-related information acquisition unit 11 supplies the imaging region to the scanning path generation unit 14. In addition, the screen generation unit 15 generates the priority input screen 230 in FIG. 13 and supplies the generated screen to the display control unit 16.

In step S22, the display control unit 16 causes the display unit 17 to display the priority input screen 230 supplied from the screen generation unit 15. At this time, the user changes the arrangement of each piece of the scanning path condition information on the basis of the desired priority of the scanning path condition indicated by the scanning path condition information in the priority input unit 231 of the priority input screen 230. Alternatively, the user operates the scanning information setting button 34.

In step S23, the screen generation unit 15 determines whether or not the scanning information setting button 34 is operated by the user on the priority input screen 230 displayed by the processing in step S22. In a case where it is determined in step S23 that the scanning information setting button 34 is not operated, the processing proceeds to step S24.

In step S24, the screen generation unit 15 determines whether or not the arrangement of the scanning path condition information of the priority input unit 231 on the priority input screen 230 displayed by the processing in step S22 has been changed. In a case where it is determined in step S24 that the arrangement of the scanning path condition information has been changed, the screen generation unit 15 updates the priority input screen on the basis of the arrangement, and supplies the updated priority input screen to the display control unit 16.

Then, in step S25, the display control unit 16 updates the priority input screen displayed on the display unit 17 on the basis of the priority input screen supplied from the display control unit 16, and the processing proceeds to step S26.

On the other hand, in a case where it is determined in step S24 that the arrangement of the scanning path condition information has not been changed, the processing proceeds to step S26.

In step S26, the condition acquisition unit 12 determines whether or not the user has operated the generation button 232 on the priority input screen. In a case where it is determined in step S26 that the generation button 232 has been operated, the processing proceeds to step S27.

In step S27, the condition acquisition unit 12 acquires the priority of each scanning path condition on the basis of the arrangement of each scanning path condition information on the priority input screen currently being displayed, and supplies the priority to the scanning path generation unit 14.

In step S28, the scanning path generation unit 14 generates various scanning paths on the basis of the imaging region and the scanning information, and selects one scanning path from the scanning paths on the basis of the priority of each scanning path condition. The scanning information used at this time is acquired by, for example, step S32 described later or step S36 in FIG. 21, but in a case where the user does not input the scanning information, default scanning information is used. The scanning path generation unit 14 supplies the selected scanning path to the screen generation unit 15. The screen generation unit 15 generates a scanning path screen on the basis of the scanning path, and supplies the scanning path screen to the display control unit 16.

In step S29, the display control unit 16 causes the display unit 17 to display the scanning path screen supplied from the screen generation unit 15, and ends the scanning path generation processing.

On the other hand, in a case where it is determined in step S23 that the scanning information setting button 34 has been operated, the screen generation unit 15 generates the scanning information input screen 130 of FIG. 7 and supplies the same to the display control unit 16, and the processing proceeds to step S30. In step S30, the display control unit 16 causes the display unit 17 to display the scanning information input screen 130 supplied from the screen generation unit 15.

In step S31, the scanning information acquisition unit 13 determines whether or not the scanning information has been input by the user on the scanning information input screen 130.

In a case where it is determined in step S31 that the scanning information has not been input yet, the scanning information acquisition unit 13 waits until the scanning information is input.

On the other hand, in a case where it is determined in step S31 that the scanning information has been input, in step S32, the scanning information acquisition unit 13 acquires the scanning information and supplies the scanning information to the scanning path generation unit 14.

In a case where it is determined in step S26 that the generation button 232 has not been operated, or after the processing of step S32, the processing returns to step S23, and the subsequent processing is repeated.

On the other hand, in a case where it is determined in step S16 of FIG. 21 that the imaging information input mode button 33 is not operated, the processing proceeds to step S33. Since the processing of steps S33 to S36 is similar to the processing of steps S23 and S30 to S32 of FIG. 22, the description thereof will be omitted.

In a case where it is determined in step S33 that the scanning information setting button 34 has not been operated, or after the processing of step S36, the processing returns to step S12, and the subsequent processing is repeated.

As described above, in the information processing apparatus 10, the imaging region-related information acquisition unit 11 acquires the imaging region-related information, the condition acquisition unit 12 acquires the priority of the scanning path condition, and the display control unit 16 displays the scanning path on the basis of the imaging region-related information and the priority. Therefore, the information processing apparatus 10 can present the scanning path of the drone 90 desired by the user.

Note that the scanning information setting button 34 may be provided only on one of the mode selection screen 30 and the priority input screen 230 (270, 310, or 350). The scanning information setting button 34 may be provided on a screen different from the mode selection screen 30 and the priority input screen 230 (270, 310, or 350).

The priority of each scanning path condition does not indicate whether or not it is necessarily required to be satisfied, and may only indicate the order of the priority level. The scanning path condition may be a condition other than the shortest scanning time condition, the shortest scanning path condition, the maximum cover ratio condition, and the minimum protrusion ratio condition. The number of scanning path conditions can be any number of one or more.

### 2. Computer

The above-described series of processing can be executed by hardware or software. In a case where the series of processing is executed by software, a program constituting the software is installed in a computer. Here, the computer includes a computer incorporated in dedicated hardware, a general-purpose personal computer capable of executing various functions by installing various programs, and the like, for example.

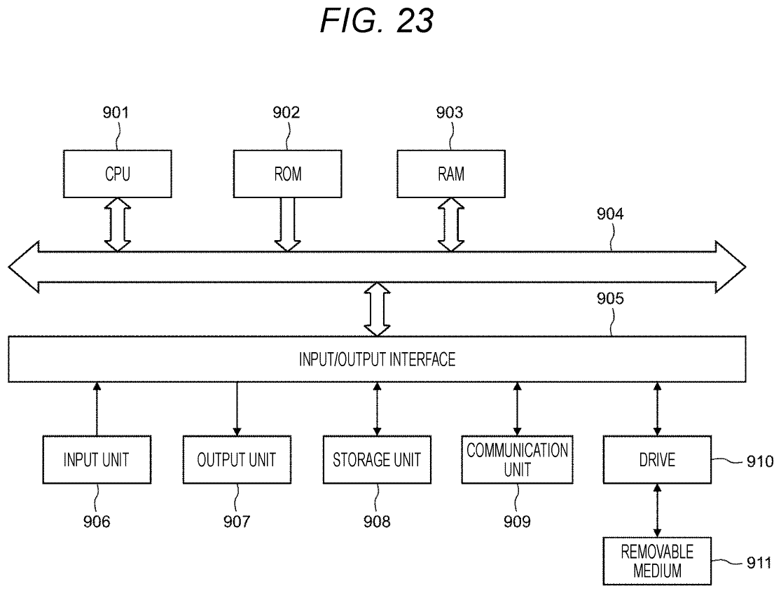

FIG. 23 is a block diagram illustrating a configuration example of hardware of a computer that executes the above-described series of processing by a program.

In the computer, a central processing unit (CPU) 901, a read only memory (ROM) 902, and a random access memory (RAM) 903 are mutually connected by a bus 904.

An input/output interface 905 is further connected to the bus 904. An input unit 906, an output unit 907, a storage unit 908, a communication unit 909, and a drive 910 are connected to the input/output interface 905.

The input unit 906 includes a keyboard, a mouse, a microphone, and the like. The output unit 907 includes the display unit 17 in FIG. 1, a speaker, and the like. The storage unit 908 includes a hard disk, a nonvolatile memory, and the like. The communication unit 909 includes a network interface and the like.

The drive 910 drives a removable medium 911 such as a magnetic disk, an optical disk, a magneto-optical disk, or a semiconductor memory.

In the computer configured as described above, for example, the CPU 901 loads a program stored in the storage unit 908 into the RAM 903 via the input/output interface 905 and the bus 904 and executes the program, whereby the above-described series of processing is performed.

The program executed by the computer (CPU 901) can be provided by being recorded in the removable medium 911 as a package medium or the like, for example. Furthermore, the program can be provided via a wired or wireless transmission medium such as a local area network, the Internet, or digital satellite broadcasting.

In the computer, the program can be installed in the storage unit 908 via the input/output interface 905 by attaching the removable medium 911 to the drive 910. Furthermore, the program can be received by the communication unit 909 via a wired or wireless transmission medium and installed in the storage unit 908. In addition, the program can be installed in the ROM 902 or the storage unit 908 in advance.

Note that the program executed by the computer may be a program in which processing is performed in time series in the order described in the present specification, or may be a program in which processing is performed in parallel or at necessary timing such as when a call is made.

The present technology can be applied to a drone that performs scanning by various control methods.

The embodiments of the present technology are not limited to the above-described embodiments, and various modifications can be made without departing from the gist of the present technology.

For example, a form in which all or some of the plurality of embodiments described above are combined can be adopted.

For example, the present technology can have a configuration of cloud computing in which one function is shared and processed in cooperation by a plurality of apparatuses via a network.

Furthermore, each step described in the above-described flowchart can be executed by one apparatus or can be shared and executed by a plurality of apparatuses.

Furthermore, in a case where a plurality of processes is included in one step, the plurality of processes included in the one step can be executed by one apparatus or can be shared and executed by a plurality of apparatuses.

Note that the effects described in the present specification are merely examples and are not limited, and effects other than those described in the present specification may be provided.

The present technology can have the following configurations.
(1)

An information processing method including:
an imaging region-related information acquisition step of acquiring, by an imaging region-related information acquisition unit, imaging region-related information related to an imaging region desired of an aerial imaging apparatus;
a condition acquisition step of acquiring, by a condition acquisition unit, priority of a condition of a scanning path of the aerial imaging apparatus; and a display control step of causing, by a display control unit, a display unit to display the scanning path on the basis of the imaging region-related information acquired by processing of the imaging region-related information acquisition step and the priority acquired by processing of the condition acquisition step.
(2)

The information processing method according to (1), in which
the imaging region-related information includes the imaging region desired.
(3)

The information processing method according to (1), in which
the imaging region-related information includes an imaging path desired, information indicating an imaging range desired at each point of the imaging path, and an imaging altitude that is a height of the aerial imaging apparatus from a ground at an imaging time desired.
(4)

The information processing method according to any one of (1) to (3), in which
the condition is at least one of a condition that a scanning time is shortest, a condition that a distance of the scanning path is shortest, a condition that a ratio of a scanning region which is a region scanned by the aerial imaging apparatus in the imaging region desired is largest, or a condition that a ratio of a region other than the imaging region desired in the scanning region is smallest.
(5)

The information processing method according to any one of (1) to (4),
further including
a scanning information acquisition step of acquiring, by a scanning information acquisition unit, scanning information including a scanning altitude and an angle of view of the aerial imaging apparatus, in which
in processing of the display control step, the display control unit causes the display unit to display the scanning path also on the basis of the scanning information acquired by processing of the scanning information acquisition step.
(6)

The information processing method according to any one of (1) to (5), in which
in the processing of the imaging region-related information acquisition step, the imaging region-related information acquisition unit acquires the imaging region-related information input by a user on a screen.
(7)

The information processing method according to any one of (1) to (6), in which
in the processing of the condition acquisition step, the condition acquisition unit acquires priority of the condition input by a user on a screen.
(8) An information processing apparatus including:
an imaging region-related information acquisition unit that acquires imaging region-related information related to an imaging region desired of an aerial imaging apparatus;
a condition acquisition unit that acquires priority of a condition of a scanning path of the aerial imaging apparatus; and
a display control unit that causes a display unit to display the scanning path on the basis of the imaging region-related information acquired by the imaging region-related information acquisition unit and the priority acquired by the condition acquisition unit.
(9)

A program for causing
a computer to function as an information processing apparatus including:
an imaging region-related information acquisition unit that acquires imaging region-related information related to an imaging region desired of an aerial imaging apparatus;
a condition acquisition unit that acquires priority of a condition of a scanning path of the aerial imaging apparatus; and
a display control unit that causes a display unit to display the scanning path on the basis of the imaging region-related information acquired by the imaging region-related information acquisition unit and the priority acquired by the condition acquisition unit.

### REFERENCE SIGNS LIST

11 Imaging region-related information acquisition unit
12 Condition acquisition unit
13 Scanning information acquisition unit
16 Display control unit
17 Display unit
50, 70 Imaging region-related information input screen
90 Drone
91 Imaging path
95 Imaging region
152 Imaging altitude
153 Imaging range angle
163 Scanning path
230, 270 Priority input screen
292 Scanning path information
310 Priority input screen
332 Scanning path information
350 Priority input screen
372, 392 Scanning path information

1. An information processing method comprising:
an imaging region-related information acquisition step of acquiring, by an imaging region-related information acquisition unit, imaging region-related information related to an imaging region desired of an aerial imaging apparatus;
a condition acquisition step of acquiring, by a condition acquisition unit, priority of a condition of a scanning path of the aerial imaging apparatus; and
a display control step of causing, by a display control unit, a display unit to display the scanning path on a basis of the imaging region-related information acquired by processing of the imaging region-related information acquisition step and the priority acquired by processing of the condition acquisition step.

2. The information processing method according to claim 1, wherein
the imaging region-related information includes the imaging region desired.

3. The information processing method according to claim 1, wherein
the imaging region-related information includes an imaging path desired, information indicating an imaging range desired at each point of the imaging path, and an imaging altitude that is a height of the aerial imaging apparatus from a ground at an imaging time desired.

4. The information processing method according to claim 1, wherein
the condition includes at least one of a condition that a scanning time is shortest, a condition that a distance of the scanning path is shortest, a condition that a ratio of a scanning region which is a region scanned by the aerial imaging apparatus in the imaging region desired is largest, or a condition that a ratio of a region other than the imaging region desired in the scanning region is smallest.

5. The information processing method according to claim 1,
further comprising
a scanning information acquisition step of acquiring, by a scanning information acquisition unit, scanning information including a scanning altitude and an angle of view of the aerial imaging apparatus, wherein
in processing of the display control step, the display control unit causes the display unit to display the scanning path also on a basis of the scanning information acquired by processing of the scanning information acquisition step.

6. The information processing method according to claim 1, wherein
in the processing of the imaging region-related information acquisition step, the imaging region-related information acquisition unit acquires the imaging region-related information input by a user on a screen.

7. The information processing method according to claim 1, wherein
in the processing of the condition acquisition step, the condition acquisition unit acquires priority of the condition input by a user on a screen.

8. An information processing apparatus comprising:
an imaging region-related information acquisition unit that acquires imaging region-related information related to an imaging region desired of an aerial imaging apparatus;
a condition acquisition unit that acquires priority of a condition of a scanning path of the aerial imaging apparatus; and
a display control unit that causes a display unit to display the scanning path on a basis of the imaging region-related information acquired by the imaging region-related information acquisition unit and the priority acquired by the condition acquisition unit.

9. A program for causing
a computer to function as an information processing apparatus including:
an imaging region-related information acquisition unit that acquires imaging region-related information related to an imaging region desired of an aerial imaging apparatus;
a condition acquisition unit that acquires priority of a condition of a scanning path of the aerial imaging apparatus; and
a display control unit that causes a display unit to display the scanning path on a basis of the imaging region-related information acquired by the imaging region-related information acquisition unit and the priority acquired by the condition acquisition unit.
